(19) United States
(12) Patent Application Publication
(10) Pub. No.: US 2007/0003336 A1
(43) Pub. Date: Jan. 4, 2007

(54) Image forming apparatus including a cleaning mechanism capable of efficiently removing residual toner

(75) Inventors: Hiromichi Ninomiya, Yokohama Shi (JP); Ken Amemiya, Tokyo (JP); Yoshiki Hozumi, Yokohama-shi (JP)

Correspondence Address: C. IRVIN MCCLELLAND;OBLON, SPIVAK, MCCLELLAND, MAIER & NEUSTADT, P.C., 1940 DUKE STREET, ALEXANDRIA, VA, 22314, US

(73) Assignee: RICOH COMPANY, LTD., Tokyo (JP)

(21) Appl. No.: 11/450,401

(22) Filed: Jun. 12, 2006

(30) Foreign Application Priority Data
Jun. 13, 2005 (JP) JP 2005-171789

(51) Int. Cl. G03G 21/00

(52) U.S. Cl. 399/346; 399/349; 399/353

(57) ABSTRACT

An image forming apparatus which includes an image carrier configured to form a latent image and a cleaning mechanism configured to clean the image carrier and including a fur brush having a brush bunch with a radially-spreading top end portion. And the cleaning mechanism further includes a solid lubricant configured to provide lubricant to the image carrier and a spring configured to give pressure to the solid lubricant towards the fur brush with a predetermined pressure.

This patent specification is based on Japanese patent applications, No. 2005-171789 filed on Jun. 13, 2005 in the Japan Patent Office, the entire contents of which are incorporated by reference herein.

### BACKGROUND OF THE INVENTION

1. Field of the Invention

The present invention relates to an image forming apparatus which includes a cleaning mechanism capable of efficiently removing residual toner.

2. Discussion of the Background

A background image forming apparatus using electrophotographic process generally includes a photosensitive drum serving as an image carrier. The photosensitive drum has a surface to be charged by an electrical discharge method. The charged surface of the photosensitive drum is exposed to a laser beam generated in accordance with image data. Thereby, an electrostatic latent image is formed on the charged surface of the photosensitive drum. The electrostatic latent image is then visualized with toner. The visualized image formed on the photosensitive drum is transferred onto a recording medium (e.g., paper) through a transfer process. After fixing the image on the recording medium, the recording medium having a fixed image is output.

In the above-described image forming procedure, this patent specification focuses on a residual toner remaining on the photosensitive drum after the transfer process. Due to various factors of electrophotographic principles, toner particles forming a toner image on the photosensitive drum are not perfectly transferred onto a recording medium. That is, some toner particles inevitably remain on the photosensitive drum which are called a residual toner. The residual toner is an obstacle for a next image forming process and needs to be removed before starting the next process.

To address the issue of residual toner, a cleaning device is to be introduced to remove the toner on the surface of the photosensitive drum so that following image processing is not affected by the residual toner.

One exemplary cleaning device includes a cleaning blade and a fur brush. The cleaning blade may have a plate shape and may be made of an elastic material, for example, a rubber material. The fur brush may have a brushy shape and may be manufactured with plastic fibers. The toner on the photosensitive drum is removed while the cleaning blade and the fur brush are sliding on the surface of the photosensitive drum with a press contact.

A variety of configurations are proposed for the cleaning device. Japanese Patent Laid-Open Application Publication No. 2004-151481 describes a cleaning device including a sheet member having holes and being rotated in synchronization with the fur brush. This configuration, however, is complicated and bears a cost penalty.

Further, Japanese Patent Laid-Open Application Publication No. 2004-212838 describes a cleaning device using a U-shaped flicker to remove toner attached to the fur brush. In this configuration, however, the residual toner on the fur brush may not stably be removed due to unstable press contact. There is no cleaning device having a fur brush capable of effectively removing residual toner so as to achieve an image forming apparatus having a long life.

### SUMMARY OF THE INVENTION

This patent specification describes a novel image forming apparatus which includes an image carrier configured to form a latent image and a cleaning mechanism configured to clean the image carrier and including a fur brush having a brush bunch with a radially-spreading top end portion.

This patent specification further describes a novel image forming apparatus which includes the fur brush with the rapidly-spreading top end portion of a brush bunch at least half time greater than a root portion of the brush bunch.

Further, this patent specification describes a novel image forming apparatus having the cleaning mechanism which includes a solid lubricant configured to provide lubricant to the image carrier and a spring configured to give pressure to a solid lubricant towards the fur brush with a predetermined pressure.

### BRIEF DESCRIPTION OF THE DRAWINGS

A more complete appreciation of the disclosure and many of the attendant advantages thereof will be readily obtained as the same becomes better understood by reference to the following detailed description when considered in connection with the accompanying drawings, wherein:

FIG. 1 illustrates an image forming apparatus according to an exemplary embodiment of the present invention;

FIG. 2 illustrates an image forming unit included in the image forming apparatus of FIG. 1; and

FIG. 3 illustrates a fur brush used in the image forming unit of FIG. 2.

### DETAILED DESCRIPTION OF PREFERRED EMBODIMENTS

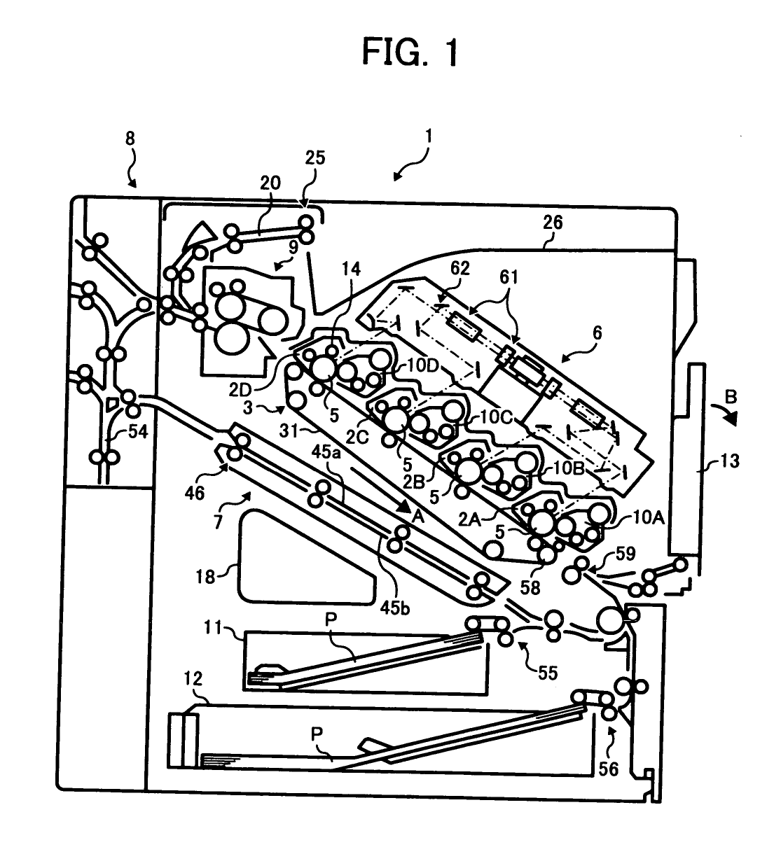

In describing preferred embodiments illustrated in the drawings, specific terminology is employed for the sake of clarity. However, the disclosure of this patent specification is not intended to be limited to the specific terminology so selected and it is to be understood that each specific element includes all technical equivalents that operate in a similar manner. Referring now to the drawings, wherein like reference numerals designate identical or corresponding parts throughout the several views, particularly to FIG. 1, an image forming apparatus according to an exemplary embodiment of the present invention is described.

FIG. 1 is an illustration of a compact full-color printer 1 as one example of the image forming apparatus according to the exemplary embodiment. The compact full-color printer 1 of FIG. 1 includes image forming units 2A to 2D, a transfer apparatus 3 and development apparatuses 10A to 10D.

Each of the image forming units 2A to 2D includes a photosensitive drum 5 serving as an image carrier, and is removably arranged in a middle section of the compact full-color printer 1. The transfer apparatus 3 includes a transfer belt 31 and is arranged under the image forming units 2A to 2D in the compact full-color printer 1. The transfer belt 31 is extended among a plurality of rollers to rotate in a direction A, as indicated by an arrow. The photosensitive drums 5 of the image forming units 2A to 2D are arranged to contact an upper surface of the transfer belt 31. The color development apparatuses 10A to 10D are arranged at positions to face corresponding image forming units 2A to 2D, respectively. The image forming units 2A to 2D have configurations similar to each other. The image forming unit 2A forms a magenta color image. Similarly, the image forming units 2B, 2C and 2D form cyan, yellow and black color image, respectively.

The compact full-color printer 1 further includes a writing unit 6, a double-side unit 7 and a reversing unit 8. The writing unit 6 is arranged over the image forming units 2A to 2D, and the double-side unit 7 is arranged under the transfer belt 31. The reversing unit 8 includes a reverse-convey path 54 and is arranged in a left side section of the compact full-color printer 1. The reversing unit 8 is configured to reverse a recording medium (e.g., a paper sheet) to prepare a second image forming on a backside of the recording medium and to output the recording medium to the double-side unit 7.

The writing unit 6 includes four light sources, a polygon scanner, a plurality of lens 61 and mirrors 62. A laser diode is used as the light source for each color. The polygon scanner includes six polygon mirrors and a polygon motor. An fθ lens, a long cylindrical lens and so on are arranged on a light path of each color. The laser beam emitted from the laser diode is deflected by the polygon scanner to become a scanning laser beam to expose the surface of the photosensitive drum 5.

The double-side unit 7 includes a pair of the convey guide plates 45a and 45b and a plurality of convey roller pairs 46. In this exemplary embodiment, four convey roller pairs 46 are arranged. When a double-side image forming mode for forming images on both sides of the recording medium is performed, the recording medium is sent to the reversing unit 8 after an image is formed on a side of the recording medium. The recording medium is conveyed to the reverse-convey path 54 and is sent to the double-side unit 7 by switching back at the reversing unit 8. The recording medium is further conveyed to a sheet supply unit, which is explained below.

The reversing unit 8 transports the recording medium to the double-side unit 7 after turning the recording medium upside down, as described above. In addition, the reversing unit 8 straightly ejects the recording medium to outside the compact full-color printer 1 without transporting the recording medium to the double-side unit 7. Further, the reversing unit 8 straightly and reversely ejects the recording medium by turning the recording medium upside down without transporting the recording medium to the double-side unit 7.

The sheet supply unit which is further included in the compact full-color printer 1 includes sheet supply cassettes 11 and 12 and sheet separation units 55 and 56. Each of the sheet supply cassettes 11 and 12 contains a plurality of recording medium. Each of the sheet separation units 55 and 56 is configured to pick up the recording medium one by one, and transport it towards the image forming units 2A-2D.

A fixing unit 9 is arranged between the transfer belt 31 and the reversing unit 8 so as to fix the image carried on the recording medium. At a position above and downstream of the fixing unit 9 in a sheet convey direction, a reversing-sheet output path 20 is arranged as a branch path which is a separation path for separating the recording medium from a path to the reversing unit 8. The recording medium which is sent to the reversing-sheet output path 20 is ejected with sheet ejection rollers 25.

The sheet supply cassettes 11 and 12 are arranged with a two-tiered configuration at a bottom part of the compact full-color printer 1. The sheet supply cassettes 11 and 12 can stock recording medium in different sizes. Further, a manual tray 13 is arranged at a right side of the compact full-color printer 1 and is configured to be able to open in a direction B. When the manual tray 13 is opened, it is possible to feed the recording medium manually through the manual tray 13.

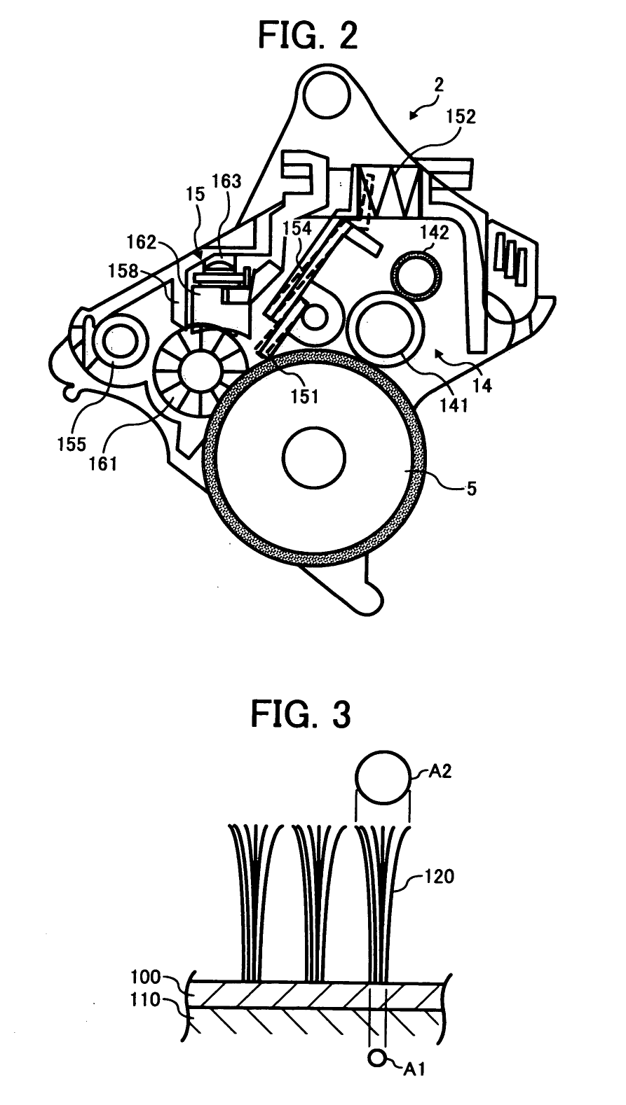

An image forming operation according to the exemplary embodiment will be described. At a start of the image forming operation, each photosensitive drum 5 rotates in a clockwise direction. A surface of the photosensitive drum 5 is uniformly charged by a charging roller 141 (see FIG. 2). A laser beam corresponding to magenta color emitted from the writing unit 6 and is caused to expos onto the photosensitive drum 5 of the image forming unit 2A. Similarly, each laser beam corresponding to each color, i.e. cyan, yellow and black, is caused to expos onto each photosensitive drum 5 of each forming unit 2B, 2C and 2D respectively. Then, electrostatic latent image corresponding to each color is formed. The electrostatic latent image is developed and visualized to form a color image at each position of each one of the color development apparatuses 10A, 10B, 10C and 10D.

Meanwhile, the recording medium is fed via the sheet separation units 55 and 56 from the sheet supply cassettes 11 and 12. The recording medium is sent to a registration roller pair 59 arranged at a position immediately before the transfer belt 31 with a timing to fit in a toner image formed on the photosensitive drum 5. The recording medium is positively charged by a sheet absorption roller 58 arranged at an entrance portion of the transfer belt 31.

The recording medium is absorbed onto the transfer belt 31 and is conveyed by the transfer belt 31. While conveying, each toner image, i.e. magenta, cyan, yellow and black, is transferred onto the recording medium serially. Thus, the color toner images are superimposed so as to form a four color image. The color toner is melted and fixed by applying pressure and heat with the fixing apparatus 9.

The recording medium having the fixed image is output through a sheet output path in accordance with a specified sheet output mode. The recording medium may be output to the sheet output tray 26 by turning the recording medium upside down. The recording medium may be output by sending straightly from the fixing apparatus 9 via the reversing unit 8. When a double-side image forming mode is selected, the recording medium is sent to the reverse convey path in the reversing unit 8 and is conveyed to the double-side unit 7 by switching back at the reversing unit 8. The recording medium is fed again to the image forming units in which image forming units 2A, 2B, 2C and 2D are arranged. A backside image is formed at a backside of the recording medium and the recording medium is output.

The photosensitive drum 5 is released from the transfer belt 31 while being rotated. A fur brush scrapes a lubricant from a solid lubricant 162 and coats the lubricant onto the photosensitive drum 5. The process steps above described are repeated. The lubricant film coated on the photosensitive drum 5 is so thin that the lubricant film does not affect the charging performance processed by the charging apparatus 14.

Each of the development apparatuses 10A to 10D includes a development roller, a screw, a toner concentration sensor and so on. The development roller is arranged to face the photosensitive drum 5. The screw is configured to convey and to stir the toner. The development roller includes a sleeve and a magnet. The sleeve is rotatably arranged at an outer side of the development roller. The magnet is fixedly arranged at an inner side of the development roller. The toner is supplied from a toner supply unit in accordance with the toner concentration sensor. In this exemplary embodiment, two-component developer which includes toner and carrier is used as a developer.

The carrier generally has a simple structure with a core particle, or a double-layer structure with the core particle and a coated layer. Ferrite and magnetite can be used for a resin coated core particle. A suitable diameter for the core particle may be in a range of from approximately 20 μm to approximately 65 μm, preferably in a range of approximately 30 μm to approximately 60 μm. The resin used to coat the core particle may be a styrene resin, an acrylic resin, a fluorocarbon resin, a silicon resin, mixture of the resins and copolymer of the resins. Spraying method, dipping method and so on are used to coat the resin on the surface of the core particle of the carrier similar to common coating process.

FIG. 2 illustrates a schematic of the image forming unit 2. The image forming unit 2 includes the photosensitive drum 5, the charging apparatus 14 and a cleaning apparatus 15. The photosensitive drum 5 forms an electrostatic latent image, and the charging apparatus 14 charges the surface of the photosensitive drum 5. The cleaning apparatus 15 cleans the surface of the photosensitive drum 5.

The photosensitive drum 5 may be formed with photoconductive amorphous metals, for example, an amorphous silicon and an amorphous selenium, or, photoconductive organic compounds, for example, Bisazo pigment, phthalicyanine pigment and so on. Taking the views of environmental problems and disposal problems after usage, the organic compounds may be desired to be used.

A variety of methods, for example, a corona discharge method, a roller method, a brush method and a blade method can be used to charge the photosensitive drum 5. In this exemplary embodiment, the charging apparatus 14 using the roller method is demonstrated. The charging apparatus 14 includes the charging roller 141, a cleaning brush 142 and a power supply (not shown). The cleaning brush 142 cleans the charging roller 141. The power supply applies a high voltage to the charging roller 141 so as to uniformly charge the surface of the photosensitive drum 5.

The cleaning apparatus 15 includes a flicker member 158, a pressuring spring 163, a cleaning blade 151, a blade support 154 and a blade pressuring spring 152 in addition to the fur brush 161 and the solid lubricant 162. The fur brush 161 removes residual toner and provides the lubricant to the photosensitive drum 5. The flicker member 158 removes residual toner attached on the fur brush 161 by flicking.

The solid lubricant 162 is a solid lubricant supplement. The pressuring spring 163 pushes the solid lubricant 162 towards the fur brush 161 with a predetermined pressure. The cleaning blade 151 is arranged at a position downstream from a contact point of the fur brush 161 and the photosensitive drum 5 in a rotational direction of photosensitive drum 5. The cleaning blade 151 removes residual toner and applies the lubricant uniformly on the surface of the photosensitive drum 5. The blade support 154 supports the cleaning blade 151. The blade pressuring spring 152 controls the contacting pressure with which the cleaning blade 151 contacts the photosensitive drum 5.

The contacting method of the cleaning blade 151 may be either a counter method or a trailing method. The counter method is more preferable in this exemplary embodiment because the counter method has a relatively high cleaning efficiency with smaller pressure which results in a less friction. Further, the cleaning blade 151 may be fixed or integrated in one piece with the blade support 154 so as to maintain an appropriate angle and the contacting pressure to the photosensitive drum 5.

A material to form the cleaning blade 151 may be any urethane rubber. However, liquid thermo-setting material may be used because of easy handling at a manufacturing process. The manufacturing processes are a prepolymer method, an one-shot method and a pseudo-one-shot method which is combination of the prepolymer method and one-shot method. More specifically, the liquid thermo-setting materials to be used are a prepolymer for urethane rubber and an agent which includes mainly curing agent. The prepolymer for urethane rubber is manufactured by polymerizing a poly-isocyanate and a polyol.

The lubricant of the solid lubricant 162 is made of a material selected from fatty acid metal chlorides and fluorocarbon resins. The fatty acid metal chlorides are, for example, lead oleate, zinc oleate, cupper oleate, zinc stearate, cobalt stearate, iron stearate, cupper stearate, zinc palmitate, cupper palmitate, zinc linolenate. The fluorocarbon resins are, for example, poly-tetrafluoro-ethylene, poly-chloro-trafluoro-ethylene, polyvinylidene fluoride, dichloro-difluoro-ethylene, copolymer of tetrafluoro-ethylene and oxafluoro-propylene.

The stearate, more specifically zinc stearate, is preferable because the zinc stearate has a larger effect to reduce a friction with the photosensitive drum 5. As for the solid lubricant 162, a bar of fatty acid metal chloride can be used by being melted and solidified.

The fur brush 161 has a shape extending in a direction towards a shaft of the photosensitive drum 5. The fur brush 161 is rotated in a same direction as a rotating direction of the photosensitive drum 5 at a point contacting with the photosensitive drum 5. The pressuring spring 163 presses the solid lubricant 162 to the fur brush 161 so as to consume most of the solid lubricant 162. As a result, the thickness of the solid lubricant 162 is decreased.

The fur brush 161 scrapes the lubricant. The fur brush 161 supplies and coats the lubricant onto the surface of the photosensitive drum 5. A coating amount of the lubricant to the photosensitive drum 5 is possible to adjust with the weight of the solid lubricant 162 itself and by the pressure of the pressuring spring 163. In this exemplary embodiment, a pressuring strength of the pressuring spring 163 is controlled so as to be adjusted.

FIG. 3 illustrates a part of the fur brush 161 according to the exemplary embodiment. The fur brush 161 includes insulating polyester fibers and is sewed on an insulating ground fabric 100. An adhesive is coated at the sewing point so that the polyester fibers are not unbound. As the insulating material is used for the adhesive, it is possible to reduce affection to the surface potential of the photosensitive drum 5. The residual toner having opposite polarity is removed efficiently.

The fur brush 161 is completed by wrapping the ground fabric 100 having a brush bunch 120 of the polyester fibers around a shaft 110 of the fur brush 161. As shown in FIG. 3, a top portion of the brush bunch 120 of the fur brush 161 is wider than a root portion of the brush bunch 120. If the brush bunches 120 are satisfying a formula
A2≧1.5×A1,
where A1 is a cross-sectional area of the root portion of the brush bunch 120 and A2 is the top portion of a brush bunch 120, a contact density of the brush bunch 120 with the photosensitive drum 5 can be made uniform in an area in which the brush bunch 120 faces the photosensitive drum 5.

As a result, the lubricant is uniformly coated in a longitude direction of the photosensitive drum 5. It is possible to obtain a longer operating life of the photosensitive drum 5.

As for a manufacturing process of the fur brush, it may be performed to make the top portion of the brush bunch 120 wider than the root portion of the brush bunch 120 before wrapping the ground fabric 100 around the shaft 110 of the brush bunch 120. Further, the brush bunch 120 is made correctively to be bent in a rotation direction of the fur brush 161. Moreover, it is also performed to make the brush bunch 120 to be bent before wrapping the ground fabric 100 around the shaft 110.

A series of these manufacturing processes is processed during a lacing process to sew the brush bunch 120 to the ground fabric 100. Low manufacturing cost can be achieved because of easy handling at the manufacturing steps. If the process to make the fur brush having a desired shape is processed after an assembly of the brush bunch 120 is completed, the handling may be difficult.

In this exemplary embodiment, the flicker member 158 is not an U-shaped flicker but is a rib-shaped plate so that it is easy to remove residuals attached on the fur brush 161 such as residual toner. In this exemplary embodiment, the fur brush 161 has an spread end of the brush bunch 120 and the brush bunch 120 is bent in a rotational direction of the fur brush. Therefore, it is possible to rotate the fur brush 161 with a smaller torque even if the flicker member 158 is pressing the fur brush 161.

Moreover, the lubricant is less consumed at each cycle so that a life time of the solid lubricant 162 can be improved. Further, comparing to the image forming apparatus which does not include an improved fur brush having a spread end of a brush bunch and a slant brush bunch, the life time of the image forming apparatus can be improved because it is possible to keep a constant friction coefficient for a long term.

Numerous additional modifications and variations are possible in light of the above teachings. It is therefore to be understood that within the scope of the appended claims, the disclosure of this patent specification may be practiced otherwise than as specifically described herein.

What is claimed is:

1. An image forming apparatus comprising:
an image carrier configured to form a latent image; and
a cleaning mechanism configured to clean the image carrier and including a fur brush having a brush bunch with a radially-spreading top end portion.

2. The image forming apparatus of claim 1, wherein the radially-spreading top end portion of the brush bunch has a cross-section area at least half time greater than a root portion of the brush bunch.

3. The image forming apparatus of claim 1, wherein the brush bunch is bent in a rotational direction of the fur brush.

4. The image forming apparatus of claim 1, wherein the brush bunch is sewed on a ground fabric.

5. The image forming apparatus of claim 1, wherein the ground fabric is wrapped around a shaft of the fur brush.

6. The image forming apparatus of claim 1, wherein the brush bunch of the fur brush includes polyester fibers.

7. The image forming apparatus of claim 4, wherein the ground fabric includes an insulating material.

8. The image forming apparatus of claim 4, wherein a sewing point of the brush bunch is coated with an adhesive.

9. The image forming apparatus of claim 1, further comprising:
a flicker member configured to contact the fur brush with a predetermined pressure.

10. The image forming apparatus of claim 1, further comprising:
a cleaning blade arranged at a position downstream from a contact point of the fur brush and the image carrier in a rotational direction of the image carrier.

11. The image forming apparatus of claim 1, further comprising:
a solid lubricant configured to provide lubricant to the image carrier; and
a spring configured to give pressure to the solid lubricant towards the fur brush with a predetermined pressure.

12. The image forming apparatus of claim 11, wherein a supply amount of lubricant is controlled by the pressure of the spring or weight of the solid lubricant itself.

13. The image forming apparatus of claim 9, wherein the flicker member is arranged at a position downstream from the solid lubricant in a rotational direction of the fur brush.

14. An image forming apparatus comprising:
an image carrier means for forming a latent image; and
a cleaning means for cleaning the image carrier means and including a fur brush having a brush bunch with a radially-spreading top end portion.
